(19) United States
(12) Patent Application Publication
(10) Pub. No.: US 2025/0103090 A1
(43) Pub. Date: Mar. 27, 2025

(54) DEVICES, SYSTEMS, AND METHODS FOR DYNAMICALLY CHANGING FREQUENCIES OF CLOCKS FOR THE DATA LINK LAYER WITHOUT DOWNTIME

(71) Applicant: ATI Technologies ULC, Markham (CA)

(72) Inventors: Shaofeng An, Markham (CA); YanFeng Wang, Markham (CA)

(73) Assignee: ATI Technologies ULC, Markham (CA)

(21) Appl. No.: 18/476,082

(22) Filed: Sep. 27, 2023

(51) Int. Cl. G06F 1/08

(52) U.S. Cl. CPC G06F 1/08

(57) ABSTRACT

An exemplary method for dynamically changing frequencies of clocks for the data link layer without downtime involves switching a first queue on a first end of a data link and a second queue on a second end of the data link from a pacing mode to an asynchronous mode. The exemplary method also involves modifying a frequency of a clock associated with the data link. The exemplary method further involves returning the first queue and the second queue from the asynchronous mode to the pacing mode upon modifying the frequency of the clock. Various other devices, systems, and methods are also disclosed.

### BACKGROUND

Computing devices often include clocks whose signals are used to synchronize processes performed by digital circuits. In some examples, computing devices implement certain features and/or modes that call for a change of the frequency of certain clocks. For example, a pair of computing devices are communicatively coupled to each other via a data link. In this example, one of those computing devices needs to take down, suspend, and/or deactivate the data link to change the frequency of a clock for the data link in response to the implementation of a certain feature or mode. The instant disclosure, therefore, identifies and addresses a need for additional and improved devices, systems, and methods that support dynamically changing frequencies of clocks for the data link layer without downtime.

### BRIEF DESCRIPTION OF THE DRAWINGS

The accompanying drawings illustrate a number of exemplary implementations and are a part of the specification. Together with the following description, these drawings demonstrate and explain various principles of the instant disclosure.

FIG. 1 is a block diagram of an exemplary system for dynamically changing frequencies of clocks for the data link layer without downtime according to one or more implementations of this disclosure.

FIG. 2 is a block diagram of an exemplary system for dynamically changing frequencies of clocks for the data link layer without downtime according to one or more implementations of this disclosure.

FIG. 3 is a set of exemplary timing diagrams that represent a sequence of events involved in dynamically changing frequencies of clocks for a data link without downtime according to one or more implementations of this disclosure.

FIG. 4 is a block diagram of an exemplary implementation involved in dynamically changing the frequencies of clocks for the data link layer without downtime according to one or more implementations of this disclosure.

FIG. 5 is a flowchart of an exemplary method for dynamically changing frequencies of clocks for the data link layer without downtime according to one or more implementations of this disclosure.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the instant disclosure covers all modifications, equivalents, and alternatives falling within the scope of the appended claims.

### DETAILED DESCRIPTION OF EXEMPLARY IMPLEMENTATIONS

The present disclosure describes various devices, systems, and methods for dynamically changing frequencies of clocks for the data link layer without downtime. In some examples, a computing device can implement a power-management feature and/or mode that calls for changing the frequency of the clock responsible for the data link layer and/or the media access control (MAC) layer. In one example, the computing device can be communicatively coupled to a remote device via the data link layer and/or MAC layer. In this example, the computing device can take down, suspend, and/or deactivate the data link to change the frequency of a clock for the data link layer and/or MAC layer in response to the implementation of the power-management feature and/or mode. By doing so, the computing device can avoid and/or prevent a situation and/or event that causes the queues implemented for the data link layer and/or MAC layer to overflow and/or underflow. Unfortunately, this takedown, suspension, and/or deactivation of the data link can introduce significant latency into the system, thus negatively impacting the system's performance.

As will be described in greater detail below, the various devices, systems, and/or methods described in the present disclosure can eliminate, obviate, and/or overcome the need to take down, suspend, and/or deactivate the data link before changing the frequency of the clock for the data link layer and/or MAC layer. For example, a system can include and/or represent a pair of computing devices that are communicatively coupled to each other via a data link. In one example, processors incorporated in these computing devices can switch first-in-first-out (FIFO) queues implemented on both ends of the data link from pacing mode (also sometimes referred to as predict mode) to asynchronous mode (also sometimes referred to as credit mode). In this example, the processors can then reduce the frequencies of their respective MAC clocks associated with the data link. Upon modifying the frequencies of their respective MAC clocks, the processors can return the FIFO queues from the asynchronous mode to the pacing mode. These steps, features, and/or actions can be achieved or carried out in a variety of different ways.

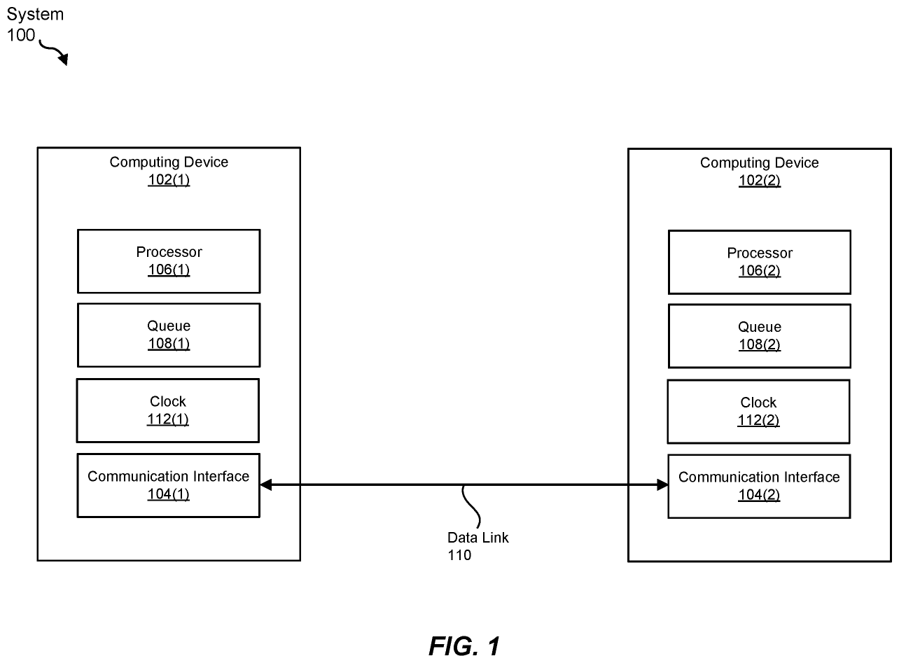

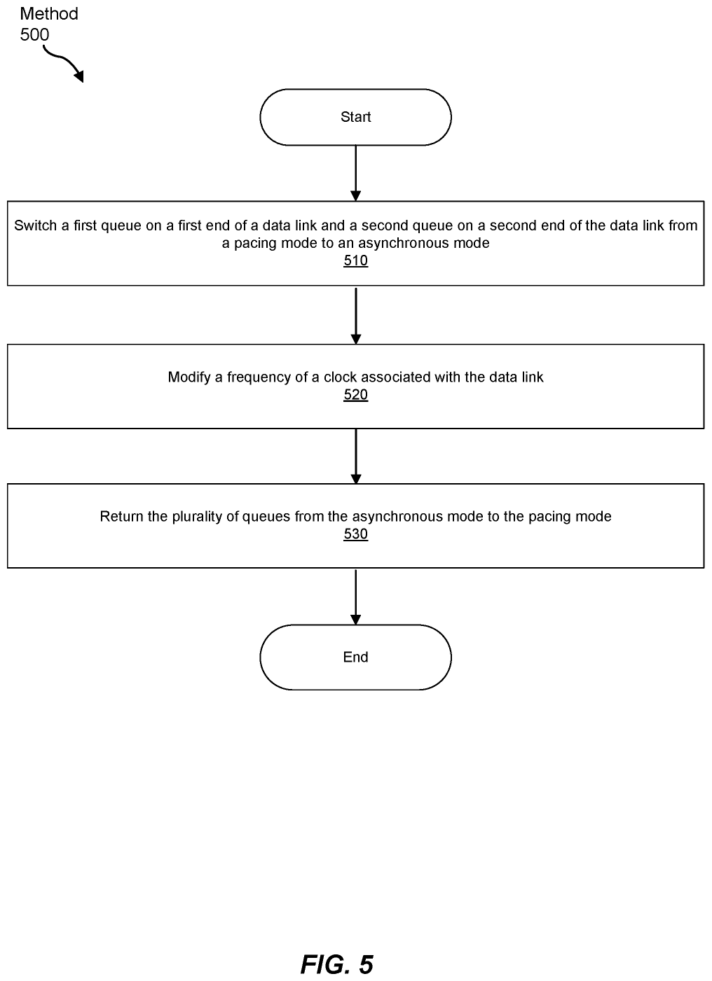

The following will provide, with reference to FIGS. 1-4, detailed descriptions of exemplary devices, systems, and/or corresponding implementations for dynamically changing frequencies of clocks for the data link layer without downtime. Detailed descriptions of an exemplary method for dynamically changing frequencies of clocks for the data link layer without downtime will be provided in connection with FIG. 5.

FIG. 1 illustrates an exemplary system 100 that facilitates and/or supports dynamically changing frequencies of clocks for the data link layer without downtime. As illustrated in FIG. 1, exemplary system 100 can include and/or represent computing devices 102(1) and 102(2) communicatively coupled to one another via a data link 110. In some examples, computing device 102(1) can include and/or represent a communication interface 104(1), a processor 106(1), a queue 108(1), and/or a clock 112(1). Additionally or alternatively, computing device 102(2) can include and/or represent a communication interface 104(2), a processor 106(2), a queue 108(2), and/or a clock 112(2). In certain implementations, computing devices 102(1) and 102(2) can represent and/or constitute opposing ends of data link 110.

In some examples, communication interfaces 104(1) and 104(2) can facilitate, support, establish, and/or provide data link 110 for and/or on behalf of computing devices 102(1) and 102(2), respectively. In one example, communication interfaces 104(1) and 104(2) can facilitate, support, and/or provide a direct connection without any intermediary nodes between computing devices 102(1) and 102(2). In another example, communication interfaces 104(1) and 104(2) can facilitate, support, and/or provide an indirect connection with one or more intermediary nodes between computing devices 102(1) and 102(2). For example, communication interfaces 104(1) and 104(2) can facilitate, support, and/or provide a connection through a local area network (such as an Ethernet network), a personal area network, a wide area network, a private network (e.g., a virtual private network), a telephone or cable network, a cellular telephone connection, a satellite data connection, wireless or wired connections, the Internet, combinations or variations of one or more of the same, and/or any other suitable communication mechanism and/or channel.

Examples of communication interfaces 104(1) and 104(2) include, without limitation, link adapters, wired network interfaces, network interface cards, wireless network interfaces, wireless network interface cards, serializer/deserializer (SerDes) interfaces, universal chiplet interconnect express (UCle) interfaces, host adapters (such as small computer system interface (SCSI) host adapters, universal serial bus (USB) host adapters, IEEE 1394 host adapters, and/or external SATA (eSATA) host adapters), advanced technology attachment (ATA), parallel ATA (PATA), serial ATA (SATA), fibre channel interface adapters, Ethernet adapters, combinations or variations of one or more of the same, and/or any other suitable communication interfaces. Although illustrated as single units in computing devices 102(1) and 102(2) of FIG. 1, communication interfaces 104(1) and 104(2) can each include and/or represent a collection of multiple communication interfaces implemented on computing devices 102(1) and 102(2), respectively.

In some examples, data link 110 can carry, exchange, and/or provide traffic via the data link layer of the Open Systems Interconnection (OSI) model. In one example, the data link layer can include and/or represent certain sub-layers, such as the logic link control (LLC) layer and the MAC layer. In this example, data link 110 can carry, exchange, and/or provide traffic via the MAC layer within the data link layer. Accordingly, clocks 112(1) and 112(2) can service and/or be associated with the data link layer and/or the MAC layer.

In some examples, data link 110 can include and/or represent any type or form of physical cable, line, signal, and/or cord capable of establishing communication between computing devices 102(1) and 102(2). Examples of data link 110 include, without limitation, Quad Small Form-factor Pluggable (QSFP) cables, Ethernet cables, fiber optic cables, Fibre Channel cables, optical cables, InfiniBand cables, CXP cables, Multiple-Fiber Push-On/Pull-Off (MPO) cables, XAUI cables, XFP cables, XFI cables, C Form-factor Pluggable (CFP) cables, variations or combinations of one or more of the same, and/or any other suitable data link.

In some examples, processors 106(1) and 106(2) can each include and/or represent a hardware-implemented device and/or circuit capable of executing firmware, an operating system, and/or applications. For example, processors 106(1) and 106(2) can each include and/or represent a central processing unit (CPU), a CPU core, a graphics processing unit (GPU), and/or a GPU core. In one example, processors 106(1) and 106(2) can each include and/or represent one of several processors (e.g., several x86 processors) implemented and/or disposed on a system on a chip (SoC). Additional examples of processors 106(1) and 106(2) include, without limitation, parallel accelerated processors, tensor cores, microprocessors, microcontrollers, field-programmable gate arrays (FPGAs), application-specific integrated circuits (ASICs), chiplets, portions of one or more of the same, variations or combinations of one or more of the same, and/or any other suitable processors. Although illustrated as single units in computing devices 102(1) and 102(2) of FIG. 1, processors 106(1) and 106(2) can each include and/or represent a collection of multiple processors implemented on computing devices 102(1) and 102(2), respectively.

In some examples, processors 106(1) and 106(2) can each implement and/or be configured with any of a variety of different architectures and/or microarchitectures. For example, processors 106(1) and 106(2) can each implement and/or be configured as a reduced instruction set computer (RISC) architecture. In another example, processors 106(1) and 106(2) can each implement and/or be configured as a complex instruction set computer (CISC) architecture. Additional examples of such architectures and/or microarchitectures include, without limitation, 16-bit computer architectures, 32-bit computer architectures, 64-bit computer architectures, x86 computer architectures, advanced RISC machine (ARM) architectures, microprocessor without interlocked pipelined stages (MIPS) architectures, scalable processor architectures (SPARCs), load-store architectures, portions of one or more of the same, combinations or variations of one or more of the same, and/or any other suitable architectures or microarchitectures.

In some examples, queues 108(1) and 108(2) can each include and/or represent any type or form of data structure and/or buffer associated with communication interfaces 104(1) and 104(2), data link 110, and/or a MAC layer. In one example, queues 108(1) and 108(2) can each include and/or represent a FIFO queue that facilitates and/or supports data link 110. For example, queues 108(1) and 108(2) can each organize, manage, and/or store data slated for transmission and/or transfer across data link 110. In this example, queues 108(1) and 108(2) can each be positioned and/or incorporated in the data paths of computing devices 102(1) and 102(2), respectively. Although illustrated as single units in computing devices 102(1) and 102(2) of FIG. 1, queues 108(1) and 108(2) can each include and/or represent a collection of multiple queues implemented on computing devices 102(1) and 102(2), respectively.

In some examples, clocks 112(1) and 112(2) can each include and/or represent any type or form digital and/or system clock implemented on computing devices 102(1) and 102(2), respectively. In one example, clocks 112(1) and 112(2) can each include and/or represent a fabric and/or MAC clock associated with the data link layer and/or the MAC layer. Although illustrated as single units in computing devices 102(1) and 102(2) of FIG. 1, clocks 112(1) and 112(2) can each include and/or represent a collection of multiple clocks implemented on computing devices 102(1) and 102(2), respectively.

In some examples, processors 106(1) and 106(2) can switch and/or change queues 108(1) and 108(2), respectively, from pacing mode to asynchronous mode. In one example, the pacing mode can involve the transmitter side determining the bandwidth of each segment in data link 110 and then controlling and/or regulating the flow of traffic across data link 110 based at least in part on the bandwidths of those segments. For example, computing device 102(1) can represent and/or constitute the transmitter, and computing device 102(2) can represent and/or constitute the receiver. In this example, processor 106(1) of computing device 102(1) can know and/or determine the available bandwidths of data link 110, communication interface 104(1), and/or communication interface 104(2). Processor 106(1) can then supply and/or provide an amount of traffic to communication interface 104(1) for transmission to communication interface 104(2) via data link 110 in compliance with those available bandwidths.

In one example, the asynchronous mode can involve the transmitter side receiving credits and/or allotments for traffic from the receiver side and then controlling and/or regulating the flow of traffic across data link 110 based at least in part on those credits and/or allotments. For example, computing device 102(1) can represent and/or constitute the transmitter, and computing device 102(2) can represent and/or constitute the receiver. In this example, processor 106(2) of computing device 102(2) can generate and/or create a credit and/or allotment representative of the amount of traffic for computing device 102(1) to transmit via data link 110. Upon receiving this create and/or allotment from computing device 102(2), processor 106(1) of computing device 102(1) can supply and/or provide an amount of traffic to communication interface 104(1) for transmission to communication interface 104(2) via data link 110 in compliance with the credit and/or allotment. Processor 106(1) of computing device 102(1) can wait until receiving a subsequent credit and/or allotment from computing device 102(2) before transmitting more traffic via data link 110.

In some examples, computing devices 102(1) and 102(2) can modify the frequency of clocks 112(1) and 112(2) to accommodate and/or comply with a power management feature or mode that affects data link 110. For example, upon switching queue 108(1) from pacing mode to asynchronous mode, processor 106(1) can reduce and/or decrease the frequency of clock 112(1) without taking down, suspending, and/or deactivating data link 110. Similarly, upon switching queue 108(2) from pacing mode to asynchronous mode, processor 106(2) can reduce and/or decrease the frequency of clock 112(2) without taking down, suspending, and/or deactivating data link 110. By reducing and/or decreasing the frequencies of clocks 112(1) and 112(2) in this way, processors 106(1) and 106(2) can prevent an overflow and/or underflow event or condition in queues 108(1) and 108(2) as a result of the power management feature or mode. In certain implementations, processors 106(1) and 106(2) can confirm and/or ensure that queues 108(1) and 108(2), respectively, have completed the switch to the asynchronous mode prior to modifying the frequencies of clocks 112(1) and 112(2), respectively.

In one example, computing devices 102(1) and 102(2) can exchange traffic across data link 110 during the modification to the frequencies of clocks 112(1) and 112(2) and/or at a specific moment in time. In other words, even as the clock frequencies are reduced and/or decreased to accommodate and/or comply with a power management feature, computing devices 102(1) and 102(2) can continue transmitting and/or receiving traffic across data link 110 because queues 108(1) and 108(2) are now operating in asynchronous mode, as opposed to pacing mode. Accordingly, computing devices 102(1) and 102(2) can maintain and/or keep data link 110 active or in mission mode as the frequencies of clocks 112(1) and 112(2) are reduced at that specific moment in time. After modification to the frequencies of clocks 112(1) and 112(2), computing devices 102(1) and 102(2) can return and/or restore queues 108(1) and 108(2) from the asynchronous mode to the pacing mode.

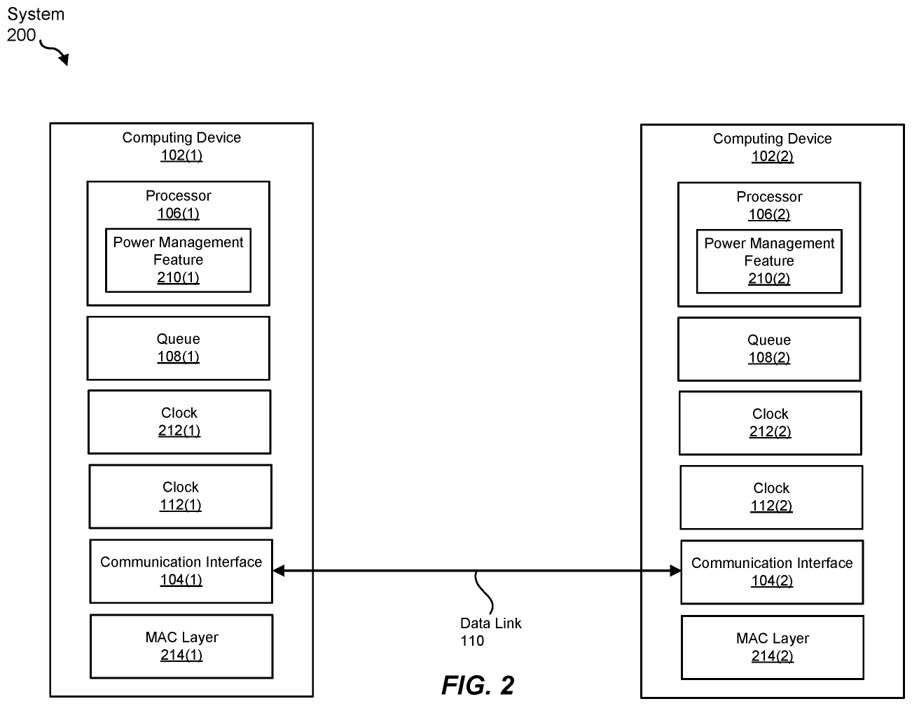

FIG. 2 illustrates an exemplary system 200 that facilitates and/or supports dynamically changing frequencies of clocks for the data link layer without downtime. In some examples, system 200 can include and/or represent certain components and/or features that perform and/or provide functionalities that are similar and/or identical to those described above in connection with FIG. 1. As illustrated in FIG. 2, in addition to those components and/or features described above in connection with FIG. 1, computing devices 102(1) and 102(2) can also include and/or represent power management features 210(1) and 210(2), MAC layers 214(1) and 214(2), and/or clocks 212(1) and 212(2), respectively.

In some examples, computing devices 102(1) and 102(2) can initiate the process of switching queues 108(1) and 108(2) to asynchronous mode and then modifying the frequency of clocks 112(1) and 112(2) in response to the activation of power management feature 210(1) or 210(2). For example, processor 106(1) can implement and/or detect power management feature 210(1). In this example, power management feature 210(1) can call for and/or cause processor 106(1) and/or other components of computing device 102(1) to operate at a reduced power level. Similarly, processor 106(2) can implement and/or detect power management feature 210(2). In this example, power management feature 210(2) can call for and/or cause processor 106(2) and/or other components of computing device 102(2) to operate at a reduced power level.

In some examples, as part of and/or in response to power management feature 210(1), computing device 102(1) reduces and/or decreases the amount of power dedicated to and/or consumed by clock 112(1), communication interface 104(1), and/or data link 110. Similarly, as part of and/or in response to power management feature 210(1), computing device 102(1) reduces and decreases the amount of power dedicated to and/or consumed by clock 112(1), communication interface 104(1), and/or data link 110. Accordingly, processors 106(1) and 106(2) can direct and/or cause clocks 112(1) and 112(2), respectively, to reduce and/or decrease their respective frequencies to accommodate and/or comply with power management feature 210(1) or 210(2).

As a specific example, processor 106(1) can detect the activation of power management feature 210(1) on computing device 102(1). In response to the activation of power management feature 210(1), processor 106(1) can switch queue 108(1) from pacing mode to asynchronous mode and direct computing device 102(1) to send a command to computing device 102(2) via data link 110. In addition, upon switching queue 108(1) to asynchronous mode and sending the command, processor 106(1) can reduce the frequency of clock 112(1) as part of power management feature 210(1).

Continuing with this example, computing device 102(2) can receive the command from computing device 102(1). In one example, the command can prompt, instruct, and/or direct computing device 102(2) to reduce the frequency of clock 112(2) to accommodate the activation of power management feature 210(1) on computing device 102(1). To do so, processor 106(2) can first switch queue 108(2) from pacing mode to asynchronous mode in response to the command. Processor 106(2) can then reduce the frequency of clock 112(2) to accommodate power management feature 210(1) and direct computing device 102(2) to send an acknowledgement to computing device 102(1) via data link 110.

Continuing with this example, computing device 102(1) can receive this acknowledgement from computing device 102(2). In one example, processor 106(1) can determine and/or confirm that computing device 102(2) has switched queue 108(2) to asynchronous mode and/or reduced the frequency of clock 112(2) to accommodate the activation of power management feature 210(1) based at least in part on this acknowledgement. In response to this determination and/or confirmation, processor 106(1) can return and/or restore queue 108(1) from asynchronous mode to pacing mode and/or direct computing device 102(1) to send an additional command to computing device 102(2) via data link 110.

Continuing with this example, computing device 102(2) can receive the additional command from computing device 102(1). In one example, the additional command can prompt, instruct, and/or direct computing device 102(2) to return and/or restore switch queue 108(2) from pacing mode to asynchronous mode in response to the command. Data link 110 can then operate and/or carry traffic at the reduced and/or decreased rate or speed to accommodate power management feature 210(1).

If power management feature 210(1) is subsequently deactivated on computing device 102(1), computing devices 102(1) can initiate the process of switching queues 108(1) and 108(2) to asynchronous mode and then increasing the frequency of clocks 112(1) and 112(2) in response to the deactivation of power management feature 210(1). In one example, computing devices 102(1) and 102(2) can perform any of the steps, features, and/or actions described above to accommodate the deactivation of power management feature 210(1) and/or increase the frequencies of clocks 112(1) and 112(2) back to their original states.

The various steps, features, and/or actions described above can be performed and/or carried out by any of a variety of different components found on computing devices 102(1) and 102(2). For example, one or more of processors 106(1) and 106(2) can implement and/or execute firmware that performs and/or carries out one or more of the steps, features, and/or actions described above to dynamically change the frequencies of clocks 112(1) and 112(2), respectively. In another example, hardware (e.g., data link layer and/or MAC interface) on computing devices 102(1) and 102(2) can perform and/or carry out one or more of the steps, features, and/or actions described above to dynamically change the frequencies of clocks 112(1) and 112(2), respectively.

As a specific example, firmware implemented on one or more of processors 106(1) and 106(2) can send a command to the data link layer for a high-speed protocol on both sides of data link 110. In this example, the command can direct and/or cause the data link layer to change all FIFO queues in the data path from pacing mode to asynchronous mode. In one example, the firmware can poll and/or check the statuses of the FIFO queues to confirm and/or ensure that they have changed to asynchronous mode. Once the change has been confirmed and/or ensured, the data link layer can start operating at a lower frequency.

For example, the data link layer can set clocks 112(1) and 112(2) to the lower frequencies of clocks 212(1) and 212(2) implemented by and/or incorporated in computing devices 102(1) and 102(2), respectively. In this example, clocks 212(1) and 212(2) can include and/or represent separate reference clocks of computing devices 102(1) and 102(2), respectively. Additionally or alternatively, the firmware can notify and/or inform the data link layer of the new target frequency of clocks 102(1) and 102(2) on both sides of data link 110. Once the frequencies of clocks 112(1) and 112(2) have been changed, the firmware can send an additional command to the data link layer on both sides of data link 110. This additional command can direct and/or cause the data link layer to return all FIFO queues in the data path from asynchronous mode back to pacing mode.

As an additional example, firmware implemented on one or more of processors 106(1) and 106(2) can program the data link layer to a new target frequency and/or MAC clock speed. In this example, the MAC can start and/or initiate a MAC clock change and/or notify the data link layer of the MAC clock change by deasserting a clock-stabilization signal (e.g., “clkStable”) on the MAC interface. In response to the deasserted clock-stabilization signal, the data link layer can change all FIFO queues in the data path from pacing mode to asynchronous mode and deassert a clock-request signal (e.g., “clkRequest”). The MAC clock on both sides of data link 110 can then be set to a lower frequency and/or speed.

For example, the MAC clock on both sides of data link 110 can start operating at the frequency and/or speed of a slower reference clock (e.g., “Refclk”). In this example, after the MAC clock has changed to the frequency and/or speed of the slower reference clock, the MAC can reassert the clock-stabilization signal. In response to the reasserted clock-stabilization signal, the data link layer can assert the clock-request signal. The data link layer can then change all the FIFO queues in the data path on both sides of data link 110 from asynchronous mode back to pacing mode.

As a further example, firmware implemented on processor 106(1) can send a command to the data link layer on computing device 102(1). In this example, the command can direct and/or cause the data link layer to change all FIFO queues in the data path of computing device 102(1) from pacing mode to asynchronous mode. In one example, the firmware can poll and/or check the status of the FIFO queues to confirm and/or ensure that they have changed to asynchronous mode. Upon confirming and/or ensuring that the change is complete, the firmware can program the data link layer to a new target frequency and/or MAC clock speed.

Continuing with this example, the firmware can program a clock-stabilization override (e.g., “REGS_clkStableOverride”) to “1” and program a clock-stabilization register or signal (e.g., “REGS_clkStable”) to “0” to issue a clock change request to computing device 102(2) via data link 110. In one example, the firmware can poll and/or check the status of the status register (e.g., “REGS_remoteFclkRequest”) until indicating that computing device 102(2) has acknowledged the clock change request. In this example, the firmware can program the clock-stabilization program a clock-stabilization register or signal to “0” and then program the clock-stabilization override to “0”. The firmware can then program computing device 102(1) to change all the FIFO queues in the data path of computing device 102(1) from asynchronous mode back to pacing mode.

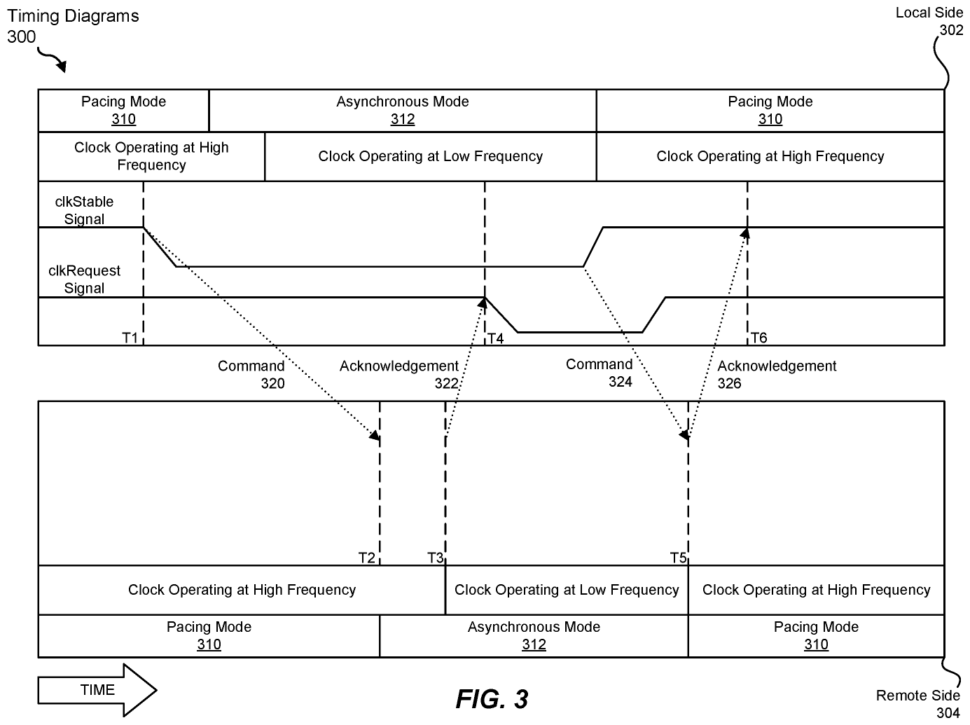

FIG. 3 illustrates exemplary timing diagrams 300 corresponding to an implementation of a system whose clock frequencies are dynamically changed for data links without downtime. In some examples, the system to which timing diagrams 300 correspond can include and/or represent certain components and/or features that perform and/or provide functionalities that are similar and/or identical to those described above in connection with either FIG. 1 or FIG. 2. In one example, timing diagrams 300 can include and/or represent an illustration corresponding to a local side 302 and another illustration corresponding to a remote side 304. In this example, local side 302 can correspond to computing device 102(1), and remote side 304 can correspond to computing device 102(2).

In some examples, firmware implemented on local side 302 can program the data link layer to a new target frequency and/or MAC clock speed. In this example, the MAC can start and/or initiate a MAC clock change and/or notify the data link layer of the MAC clock change by deasserting the clkStable signal on the MAC interface of local side 302. In response to the deasserted clkStable signal, the data link layer can issue a command 320 to remote side 304 via data link 110, change all FIFO queues in the data path on local side 302 from a pacing mode 310 to an asynchronous mode 312, and then reduce the frequency of the MAC clock on local side 302. In response to receiving command 320, remote side 304 can change all FIFO queues in its data path from pacing mode 310 to asynchronous mode 312, reduce the frequency of the MAC clock, and then issue an acknowledgement 322 to local side 302 via data link 110.

Continuing with this example, as local side 302 receives acknowledgement 322 from remote side 304, the data link layer can deassert the clkRequest signal. The MAC can then reassert the clkStable signal. In response to the reasserted clkStable signal, the data link layer can increase the frequency of the MAC clock back to its original speed, change all the FIFO queues in the data path on local side 302 from asynchronous mode 312 back to pacing mode 310, and issue a command 324 to remote side 304 via data link 110. The data link layer can then reassert the clkRequest signal. In response to receiving command 324, remote side 304 can increase the frequency of its MAC clock back to its original speed and change all the FIFO queues in its data path from asynchronous mode 312 back to pacing mode 310. Remote side 304 can then issue an acknowledgement 326 to local side 302 via data link 110.

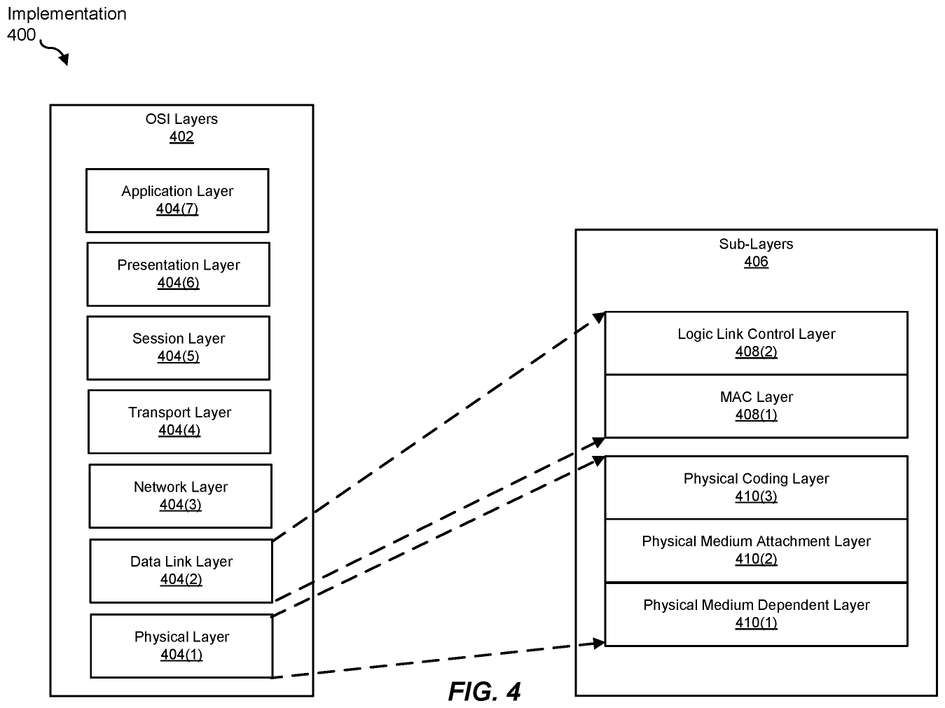

FIG. 4 illustrates an exemplary implementation 400 of components and/or features involved in dynamically changing the frequencies of clocks 112(1) and 112(2) without downtime. In some examples, implementation 400 can include and/or represent certain components and/or features that perform and/or provide functionalities that are similar and/or identical to those described above in connection with any of FIGS. 1-3. In one example, implementation 400 can include and/or represent OSI layers 402 that facilitate, support, and/or provide different network channels and/or protocols for communication. In this example, OSI layers 402 can include and/or represent a physical layer 404(1), a data link layer 404(2), a network layer 404(3), a transport layer 404(4), a session layer 404(5), a presentation layer 404(6), and/or an application layer 404(7).

In some examples, one or more of OSI layers 402 can include and/or represent a set of sub-layers 406. For example, physical layer 404(1) can include and/or represent a physical medium dependent layer 410(1), a physical medium attachment layer 410(2), and/or a physical coding layer 410(3). Additionally or alternatively, data link layer 404(2) can include and/or represent MAC layer 408(1) and/or logic link control layer 408(2). Accordingly, data link 110 may can carry, exchange, and/or provide traffic via data link layer 404(2) and/or MAC layer 408(1), and clocks 112(1) and 112(2) can service and/or be associated with data link layer 404(2) and/or MAC layer 408(1).

In some examples, the various devices and/or systems described in connection with FIGS. 1-4 can include and/or represent one or more additional circuits, components, and/or features that are not necessarily illustrated and/or labeled in FIGS. 1-4. For example, computing devices 102(1) and 102(2) can also include and/or represent additional analog and/or digital circuitry, onboard logic, transistors, resistors, capacitors, diodes, inductors, switches, registers, flipflops, connections, traces, buses, semiconductor (e.g., silicon) devices and/or structures, processing devices, storage devices, circuit boards, packages, substrates, housings, combinations or variations of one or more of the same, and/or any other suitable components that facilitate and/or support dynamically changing frequencies of clocks for the data link layer without downtime. In certain implementations, one or more of these additional circuits, components, devices, and/or features can be inserted and/or applied between any of the existing circuits, components, and/or devices illustrated in FIGS. 1-4 consistent with the aims and/or objectives provided herein. Accordingly, the electrical and/or communicative couplings described with reference to FIGS. 1-4 can be direct connections with no intermediate components, devices, and/or nodes or indirect connections with one or more intermediate components, devices, and/or nodes.

In some examples, the phrase “to couple” and/or the term “coupling”, as used herein, can refer to a direct connection and/or an indirect connection. For example, a direct coupling between two components can constitute and/or represent a coupling in which those two components are directly connected to each other by a single node that provides electrical continuity from one of those two components to the other. In other words, the direct coupling can exclude and/or omit any additional components between those two components.

Additionally or alternatively, an indirect coupling between two components can constitute and/or represent a coupling in which those two components are indirectly connected to each other by multiple nodes that fail to provide electrical continuity from one of those two components to the other. In other words, the indirect coupling can include and/or incorporate at least one additional component between those two components.

FIG. 5 is a flow diagram of an exemplary method 500 for dynamically changing frequencies of clocks for the data link layer without downtime. In one example, the steps shown in FIG. 5 can be performed and/or executed during the operation of a computing device and/or system. Additionally or alternatively, the steps shown in FIG. 5 can also incorporate and/or involve various sub-steps and/or variations consistent with the descriptions provided above in connection with FIGS. 1-4.

As illustrated in FIG. 5, exemplary method 500 includes and/or involves the step of switching a plurality of queues implemented on both ends of a data link from a pacing mode to an asynchronous mode (510). Step 510 can be performed in a variety of ways, including any of those described above in connection with FIGS. 1-4. For example, computing devices connected to one another via a data link can switch and/or change a plurality of queues implemented onboard those computing devices from a pacing mode to an asynchronous mode.

Exemplary method 500 also includes and/or involves the step of modifying a frequency of a clock associated with the data link (520). Step 520 can be performed in a variety of ways, including any of those described above in connection with FIGS. 1-4. For example, the computing devices connected to one another via the data link can reduce and/or decrease the frequencies of MAC clocks associated with the data link.

Exemplary method 500 further includes the step of returning the plurality of queues from the asynchronous mode to the pacing mode upon modifying the frequency of the clock (530). Step 530 can be performed in a variety of ways, including any of those described above in connection with FIGS. 1-4. For example, the computing devices connected to one another via the data link can switch and/or change the plurality of queues implemented onboard those computing devices from the asynchronous mode back to the pacing mode.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality. Furthermore, the various steps, events, and/or features performed by such components should be considered exemplary in nature since many alternatives and/or variations can be implemented to achieve the same functionality within the scope of this disclosure.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the instant disclosure. The implementations disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
switching a first queue on a first end of a data link and a second queue on a second end of the data link from a pacing mode to an asynchronous mode;
modifying a frequency of a clock associated with the data link; and
upon modifying the frequency of the clock, returning the first queue and the second queue from the asynchronous mode to the pacing mode.

2. The method of claim 1, further comprising exchanging traffic across the data link at a specific time; and
wherein modifying the frequency of the clock comprises modifying the frequency of the clock at the specific time.

3. The method of claim 1, wherein modifying the frequency of the clock comprises reducing the frequency of the clock without deactivating the data link.

4. The method of claim 1, further comprising detecting an activation of a power management feature that affects the data link; and
wherein modifying the frequency of the clock comprises reducing the frequency of the clock in response to detecting the activation of the power management feature.

5. The method of claim 4, further comprising:
detecting a deactivation of the power management feature; and
increasing the frequency of the clock in response to detecting the deactivation of the power management feature.

6. The method of claim 4, wherein reducing the frequency of the clock comprises preventing an overflow condition or an underflow condition in at least one of the first queue and the second queue as a result of the activation of the power management feature.

7. The method of claim 4, wherein reducing the frequency of the clock comprises maintaining the data link active as the frequency of the clock is reduced.

8. The method of claim 1, wherein:
the first queue comprises a first first-in-first-out (FIFO) queue implemented in a data path on a first computing device that represents the first end of the data link; and
the second queue comprises a second FIFO queue implemented in a data path on a second computing device that represents the second end of the data link.

9. The method of claim 8, wherein modifying the frequency of the clock comprises:
setting a first clock associated with a media access control (MAC) layer implemented on the computing device to a lower frequency of a reference clock available on the computing device; and
setting a second clock associated with an additional MAC layer implemented on the additional computing device to a lower frequency of an additional reference clock available on the additional computing device.

10. The method of claim 9, further comprising:
confirming that the first FIFO queue has switched to the asynchronous mode prior to modifying the frequency of the first clock; and
confirming that the second FIFO queue has switched to the asynchronous mode prior to modifying the frequency of the second clock.

11. The method of claim 1, wherein:
switching the first queue and the second queue to the asynchronous mode comprises switching the first queue and the second queue to the asynchronous mode via firmware implemented on the first end and the second end of the data link or a data link layer implemented across the data link;
modifying the frequency of the clock comprises modifying the frequency of the clock via the firmware or the data link layer; and
returning the first queue and the second queue from the asynchronous mode to the pacing mode via the firmware or the data link layer.

12. A system comprising:
a data link; and
a plurality of computing devices that are communicatively coupled via the data link and are configured to:
switch a first queue on a first end of the data link and a second queue on a second end of the data link from a pacing mode to an asynchronous mode;
modify frequencies of clocks associated with the data link on the plurality of computing devices; and
return the first queue and the second queue from the asynchronous mode to the pacing mode upon modifying the frequencies of the clocks.

13. The system of claim 12, wherein the plurality of computing devices are further configured to:
exchange traffic across the data link at a specific time; and
modify the frequencies of the clocks at the specific time.

14. The system of claim 12, wherein the plurality of computing devices are further configured to reduce the frequencies of the clocks without deactivating the data link.

15. The system of claim 12, wherein at least one of the plurality of computing devices is further configured to:
detect an activation of a power management feature that affects the data link; and
reduce the frequencies of the clocks in response to the activation of the power management feature.

16. The system of claim 15, wherein at least one of the plurality of computing devices is further configured to:
detect a deactivation of the power management feature; and
increase the frequencies of the clocks in response to the activation of the power management feature.

17. The system of claim 15, wherein at least one of the plurality of computing devices is further configured to prevent an overflow condition or an underflow condition in at least one of the first queue and the second queue as a result of the activation of the power management feature.

18. The system of claim 15, wherein the plurality of computing devices are further configured to maintain the data link active as the frequencies of the clocks are reduced.

19. The system of claim 12, wherein:
the first queue comprises a first first-in-first-out (FIFO) queue implemented in a data path on one of the plurality of computing devices; and
the second queue comprises a second FIFO queue implemented in a data path on another one of the plurality of computing devices.

20. A computing device comprising:
a communication interface configured to establish a data link with an additional communication interface of a remote device; and
at least one processor configured to:
switch at least one queue implemented in connection with the communication interface from a pacing mode to an asynchronous mode;
modify a frequency of at least one clock associated with the data link; and
upon modifying the frequency of the at least one clock, returning the at least one queue from the asynchronous mode to the pacing mode.
